(19) United States
(12) Patent Application Publication
(10) Pub. No.: US 2015/0199314 A1
(43) Pub. Date: Jul. 16, 2015

(54) Editing Application For Synthesized eBooks

(71) Applicant: Viresh Ratnakar, Los Altos, CA (US)

(72) Inventor: Viresh Ratnakar, Los Altos, CA (US)

(73) Assignee: GOOGLE INC., Mountain View, CA (US)

(21) Appl. No.: 12/912,444

(22) Filed: Oct. 26, 2010

(51) Int. Cl. G06F 17/24; H04L 29/08; G06F 17/22; G06F 3/048

(52) U.S. Cl. CPC G06F 17/24; G06F 17/2247; H04L 67/02

(57) ABSTRACT

A software application to assist human operators to efficiently correct errors in electronic books (eBooks) is described. The application presents the operator with a graphical user interface (GUI) including a page image of a source document (e.g., a printed publication) alongside a rendition of structured content extracted from the page image. The operator can make a structural change as well as a low-level text change in the rendition by issuing an editing command through the GUI. The editing command is sent to a server hosting an intermediate document for the source document and the page image. The server modifies the intermediate document by applying the editing command, and transmits to the application an updated rendition generated based on the modified intermediate document. The application displays the updated rendition to reflect the change made in response to the editing command.

### BACKGROUND

1. Field of Disclosure

The disclosure generally relates to the field of electronic publication, in particular to tools for editing electronic content.

2. Description of the Related Art

Because of increasing demand for electronic content, more and more printed publications (e.g., books, newspapers, and magazines) are converted into reflowable digital formats (also called “electronic books”, “eBooks”, “e-books”). A reflowable digital format (e.g., hypertext markup language (HTML)) is a digital format in which contents are not restrained to a fixed page layout and can be reflowed into different pages according the particular screen size of the electronic device (e.g., an eBook reader) displaying the contents. EBooks are often created automatically by applying Optical Character Recognition (OCR) technologies to scanned book pages, or by converting existing digital contents in formats such as the Portable Document Format (PDF) and Tagged Image File Format (TIFF) into reflowable digital formats. Such automatically created eBooks (also called “synthesized eBooks”) are often full of flaws.

Conventionally, to correct the flaws in synthesized eBooks, human operators would painstakingly edit the content pages using a full word processor or hypertext markup language (HTML) editor. The features in such editors are not tailored to efficiently address flaws commonly existing in synthesized eBooks. In addition, it is often necessary (or desirable) for the human operators to resort to additional tools to access page images of the original printed publications to identify or correct flaws in the synthesized eBooks. As a result, the editing process is inefficient and often takes the human operator a substantial amount of time to correct flaws in a short synthesized eBook. Therefore, there is a need for a tool to assist human operators to efficiently fix flaws in synthesized eBooks.

### SUMMARY

Embodiments of the present disclosure include a method (and corresponding system and computer program product) for editing an eBook for a source document (e.g., a printed publication). A graphical user interface (GUI) presented to a human operator includes a page image of the source document alongside a rendition of structured content extracted from the page image. The GUI receives an editing command from the human operator for modifying the structured content, and in response displays an updated rendition of the structured content modified by the editing command alongside the page image in place of the original rendition.

Other aspects of the present disclosure include another method (and corresponding system and computer program product) for editing an eBook for a source document. In response to a request from an eBook editing application executing on a client device, a page image of the source document together with a rendition of structured content extracted from the page image are transmitted to the eBook editing application. In response to receiving an editing command from the eBook editing application for correcting an error in the rendition, an intermediate document is modified by applying the editing command. An updated rendition is generated based on the modified intermediate document, and transmitted to the eBook editing application.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

FIGS. 1A-1B are high-level block diagrams of computing environments according to one embodiment of the present disclosure.

FIG. 2 is a high-level block diagram illustrating an example of a computer for use in the computing environment shown in FIGS. 1A-1B according to one embodiment of the present disclosure.

FIG. 3A is a high-level block diagram illustrating modules within a server according to one embodiment of the present disclosure.

FIG. 3B is a high-level block diagram illustrating modules within an eBook editing application according to one embodiment of the present disclosure.

FIG. 4 is a ladder diagram illustrating interactions between a server and a client according to one embodiment of the present disclosure.

FIG. 5 is an annotated diagram illustrating two page images according to one embodiment of the present disclosure.

FIG. 6 is a screenshot illustrating an example graphical user interface (GUI) according to one embodiment of the present disclosure.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

### System Environment

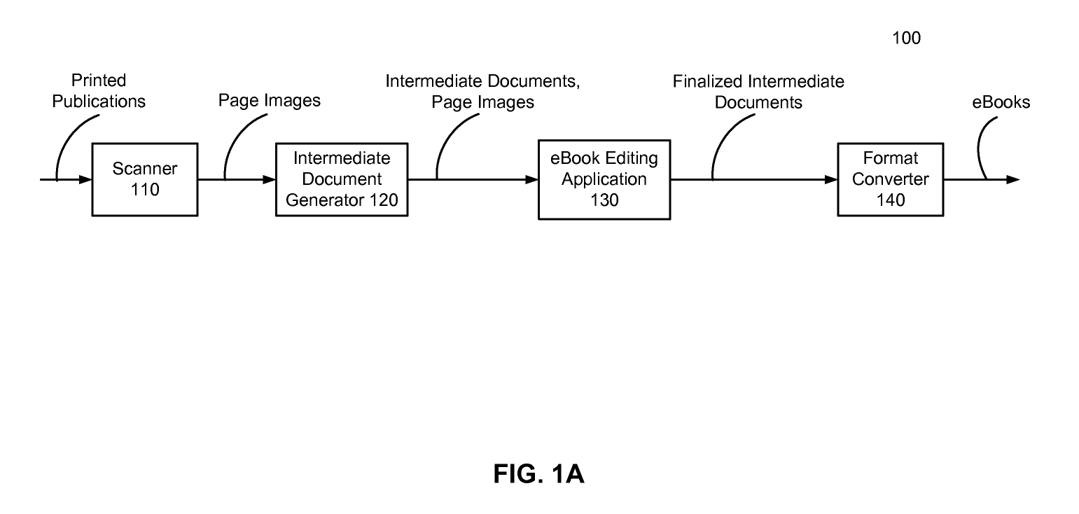

FIG. 1A is a high-level block diagram that illustrates a computing environment 100 for converting printed publications into electronic books (also called “eBooks”, “e-books”) according to one embodiment of the present disclosure. As shown, the computing environment 100 includes a scanner 110, an intermediate document generator 120, an eBook editing application 130, and a format converter 140. Only one of each entity is illustrated in order to simplify and clarify the present description. There can be other entities in the computing environment 100 as well.

The scanner 110 is a hardware device configured to optically scan printed publications (e.g., books, newspapers) and convert the printed publications into images. Contents in a book (or other types of printed publication such as newspaper) are organized into pages. The scanner 110 scans each book page and generates a page image for that book page. The scanner 110 feeds the generated page images into the intermediate document generator 120.

The intermediate document generator 120 is a hardware device and/or software program configured to extract elements (e.g., text, image, formula, table, etc.) from page images and generate an intermediate representation of the full structure of the printed publication (called the “intermediate document” or “synthesized eBook”).

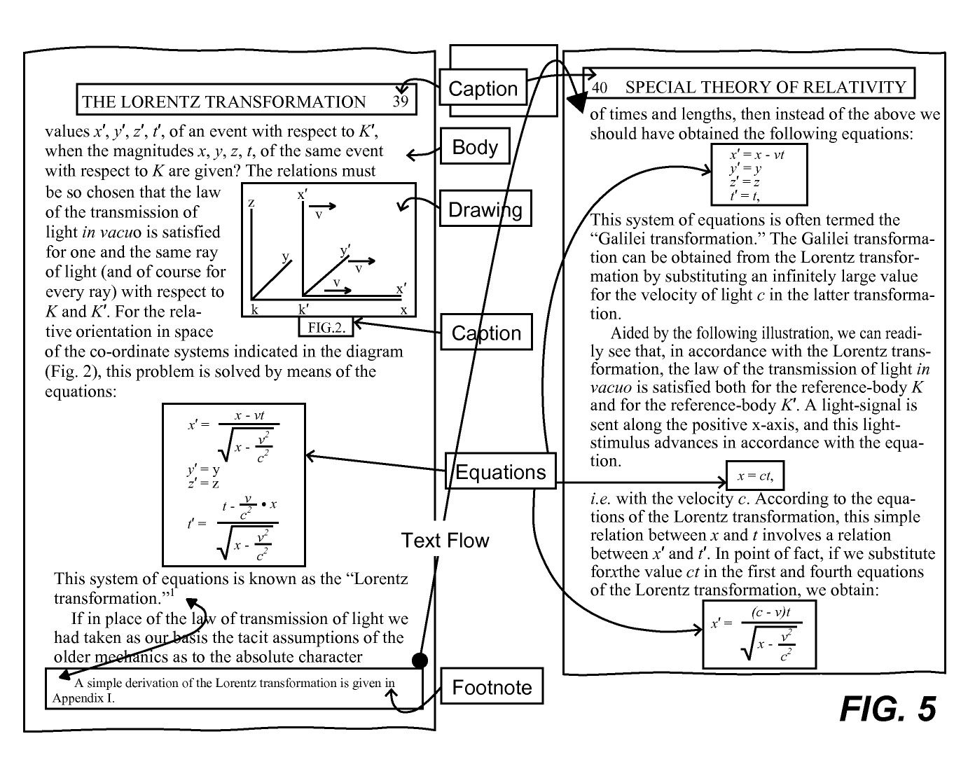

As shown in FIG. 5, an annotated diagram showing page images of two consecutive book pages, the page images may contain many interrelated elements. For example, each page may have a header identifying the content of that page and a body text flow that may continue across multiple pages. The body text flow may be organized into structural or logical units such as chapters, pages, blocks (or chapters), and paragraphs. Some of these units, such as paragraphs and blocks, may be hierarchical (e.g., a block includes one or more paragraphs), while other units are not (e.g., a block may span over several pages, and a page may include several blocks). Text in one unit may have different attributes (e.g., font, margin, indentation, alignment) compared to text in another unit. For example, one paragraph may include a line of capitalized heading in a larger font compared to the font of a paragraph of quotation, and the fonts of both may be different compared to the font of a paragraph of plain text. In addition, each structural unit may include elements other than text (e.g., image, table, formula) accompanied by other elements such as captions and annotations. In addition to the body text flow, other elements (e.g., footnotes) may span over multiple pages.

The intermediate document generator 120 detects the various types of elements (e.g., text, image, table, equation) in the page images, and analyzes their structures, attributes, and interrelationships by applying different algorithms such as Optical Character Recognition (OCR) algorithms to the page images. The intermediate document generator 120 stores the detected elements along with their structural/logical break-down, interrelationships, attributes (e.g., font, alignment, indentation), and precise physical locations on the original page images (e.g., book pages) in the intermediate documents.

The intermediate document can be in formats such as the protocol buffers structure, hypertext markup language (HTML), and extensible markup language (XML). The elements may be annotated in the intermediate documents to specify their structural/logical break-down and attributes using a hierarchy of structural tags. For example, text may be annotated using structural tags such as <BLOCK>, <PARAGRAPH>, <WORD>, <SYMBOL>, such that the structural relationship among the text segments can be uniquely defined by the associated tags. Each structural tag may include applicable attributes to further describe the associated elements. For example, a block tag (<BLOCK>) may include an attribute to specify the type of the element in the associated block (e.g., page header, footer, table, body text, footnote, heading, and image).

In one embodiment, in addition to (or instead of) the page images from the scanner 110, the intermediate document generator 120 is further configured to receive digital content in other formats (e.g., PDF/TIFF), extract text from such digital content, and generate intermediate documents for the full structure of the digital content. Depending on the specific format of the digital content, the intermediate document generator 120 may apply one or more different technologies to extract the texts. For example, the intermediate document generator 120 may extract the text layer from a PDF file and/or apply OCR algorithms to recognize text in the PDF file. In the following description, the digital content and the printed publication are collectively referred to as source documents. The outputs of the intermediate document generator 120, including the page images (or digital content in other formats) and the corresponding intermediate documents, are fed into the eBook editing application 130.

Due to reasons such as imperfections in the source documents, artifacts introduced during the scanning process, and shortcomings of algorithms applied to recognize elements and structures in the page images, errors often exist in the intermediate documents. Some of the errors are low-level text errors such as garbled words, missing text, and dropped capital letters. Other errors include high-level structural errors such as layout errors (e.g., block/paragraph/chapter segmentations, flawed boxes for images, mistaken reading order), structure identification errors, and other miscellaneous errors.

The eBook editing application 130 is a software application configured to assist a human operator to efficiently locate and correct errors in the intermediate documents. In one embodiment, the eBook editing application 130 is implemented as a web application using JavaScript and HTML, and can be launched and operated using a standard web browser. The eBook editing application 130 is designed to be a catch-all, fix-all tool to assist the operator to efficiently locate and correct errors in the intermediate documents, including the low-level text errors and the high-level structural errors described above.

The eBook editing application 130 provides the operator with page images alongside a rendition of the intermediate document(s) including content extracted from the page images. A rendition is a piece of structured content (e.g., in HTML format) generated to simulate the appearance of the content in the resulting eBook. Because the resulting eBook is paginated depending upon the dimension and resolution of the reading device, the rendition does not necessarily have the same pagination as the original printed book reflected in the page images. By displaying the rendition side-by-side with the page image from which contents of the rendition originates, the eBook editing application 130 enables the human operator to directly observe the source document and use it to improve the rendition of the intermediate document.

The operator interacts with the eBook editing application 130 to correct errors in the intermediate document and observes the updated rendition reflecting the correction in real time, until the rendition is free of errors (or acceptable). The editing commands issued by the operator can be fed back to the intermediate document generator 120 to improve the algorithms used to convert text and/or detect elements/structures in the page images (or digital content in other formats). The output of the eBook editing application 130 is fed into the format converter 140.

The format converter 140 is a hardware device and/or software program configured to convert finalized intermediate documents into eBooks. An eBook is an electronic version of a source document which captures the text and structure of the source document and can be read on a computing device such as a personal computer and a smart phone. There are many reflowable digital formats for eBooks, such as electronic publication (ePub), hypertext markup language (HTML), and extensible markup language (XML). In one embodiment, an eBook generated by the format converter 140 comprises HTML content pages, image files, and metadata including a table of contents, all bundled up in a directory (or compressed file).

FIG. 1B is a high-level block diagram that illustrates a computing environment 150 for editing intermediate documents using the eBook editing application 130, according to one embodiment of the present disclosure. As shown, the computing environment 150 includes a client 160 and a server 170 connected through a network 180. Only one of each entity is illustrated in order to simplify and clarify the present description.

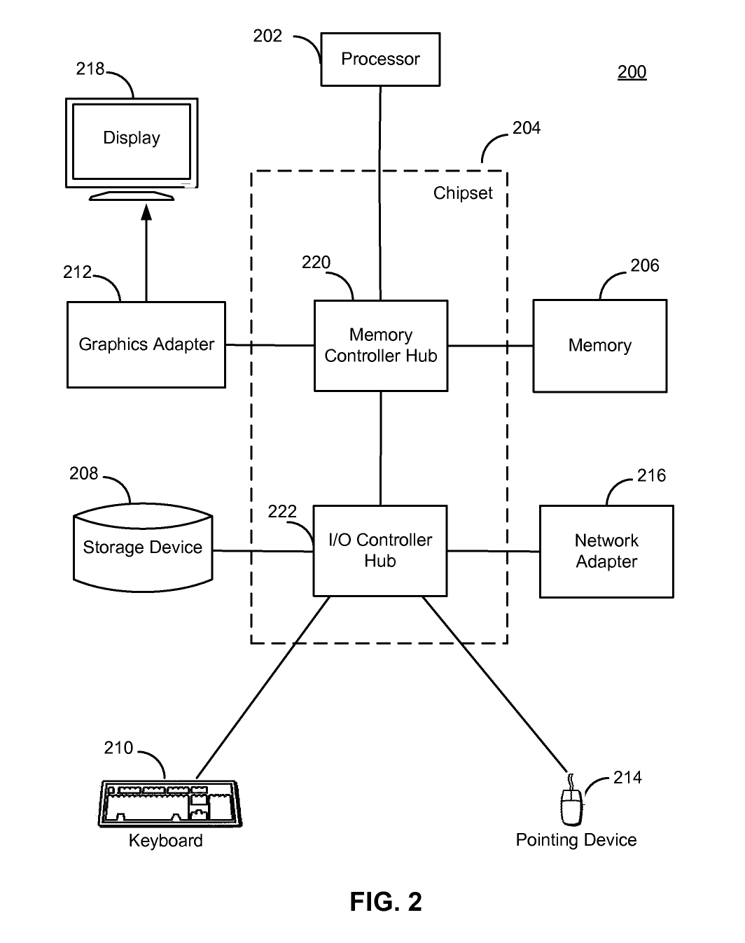

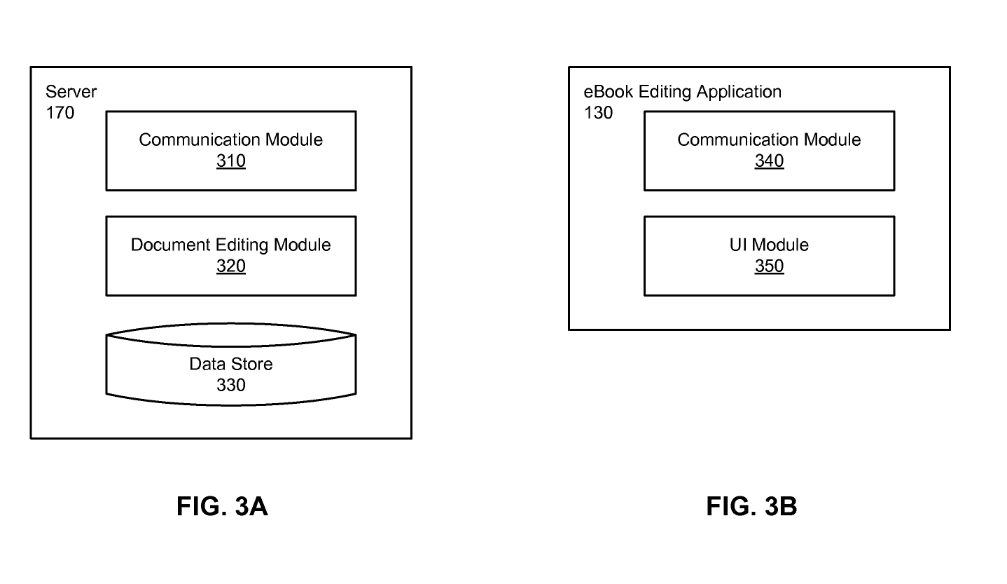

The server 170 is a hardware device and/or software program configured to provide the human operator with the eBook editing application 130 and renditions of intermediate documents along with corresponding page images (e.g., book pages). In one embodiment, the server 170 hosts (or is associated with) a website for the human operator to download the eBook editing application 130 (e.g., as a web application). The server 170 receives editing commands from the eBook editing application 130, modifies the intermediate documents by applying the editing commands, generates updated renditions for the modified intermediate documents, and transmits to the eBook editing application 130 the updated renditions in response. Once intermediate documents for a book are finalized, the server 170 converts the intermediate documents into an eBook and avails the eBook to readers. An example architecture of the server 170 is described in detail below with regard to FIG. 3A.

The client 160 is a computer system configured to enable a human operator to edit intermediate documents using the eBook editing application 130. As shown, a web browser 165 (e.g., Google Chrome™, Microsoft Internet Explorer™, Mozilla Firefox™, and Apple Safari™) executes on the client 160. The operator launches the eBook editing application 130 by using the web browser 165 to visit the server 170, and interacts with the eBook editing application 130 to select and correct errors in an intermediate document. An example architecture of the eBook editing application 130 is described in detail below with regard to FIG. 3B.

The network 180 is a system of interconnected computer networks that use standard communications technologies and/or protocols to facilitate data transmission among the computer networks. Thus, the network 180 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 180 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 180 can be represented using technologies and/or formats including the hypertext markup language (HTML), the extensible markup language (XML), JavaScript, VBScript, Flash, PDF, PostScript, etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above.

### Computer Architecture

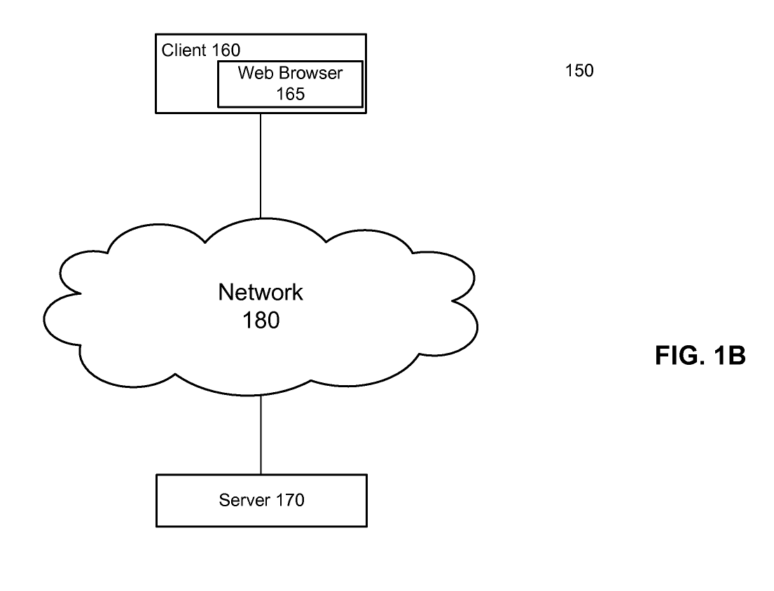

The entities shown in FIGS. 1A-B are implemented using one or more computers. FIG. 2 is a high-level block diagram illustrating an example computer 200. The computer 200 includes at least one processor 202 coupled to a chipset 204. The chipset 204 includes a memory controller hub 220 and an input/output (I/O) controller hub 222. A memory 206 and a graphics adapter 212 are coupled to the memory controller hub 220, and a display 218 is coupled to the graphics adapter 212. A storage device 208, keyboard 210, pointing device 214, and network adapter 216 are coupled to the I/O controller hub 222. Other embodiments of the computer 200 have different architectures.

The storage device 208 is a non-transitory computer-readable storage medium such as a hard drive, compact disk read-only memory (CD-ROM), DVD, or a solid-state memory device. The memory 206 holds instructions and data used by the processor 202. The pointing device 214 is a mouse, track ball, or other type of pointing device, and is used in combination with the keyboard 210 to input data into the computer 200. The graphics adapter 212 displays images and other information on the display 218. The network adapter 216 couples the computer 200 to one or more computer networks.

The computer 200 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 208, loaded into the memory 206, and executed by the processor 202.

The types of computers 200 used by the entities of FIGS. 1A-B can vary depending upon the embodiment and the processing power required by the entity. For example, the server 170 might comprise multiple blade servers working together to provide the functionality described herein. As another example, the client 160 might comprise a personal computer with limited processing power. The computers 200 can lack some of the components described above, such as keyboards 210, graphics adapters 212, and displays 218. In addition, the server 170 can run in a single computer 200 or multiple computers 200 communicating with each other through a network such as a server farm.

### Example Architectural Overview of the Server

FIG. 3A is a high-level block diagram illustrating a detailed view of modules within the server 170 according to one embodiment. Some embodiments of the server 170 have different and/or other modules than the ones described herein. Similarly, the functions can be distributed among the modules in accordance with other embodiments in a different manner than is described here. As illustrated, the server 170 includes a communication module 310, a document editing module 320, and a data store 330.

The communication module 310 communicates with the intermediate document generator 120 to receive intermediate documents and corresponding page images (or digital content in other formats), and stores the documents and images in the data store 330. In addition, the communication module 310 communicates with the client 160 to provide the eBook editing application 130 with renditions of the intermediate documents along with corresponding page images (e.g., page images from which contents in the renditions originates), and receive editing commands from the client 160. In one embodiment, files related to a source document (e.g., intermediate documents, page images) are bundled together (and/or compressed) and stored in the data store 330. When a source document (e.g., a book) is being edited by an operator, the server 170 loads the related files into memory in a compressed format, and only uncompresses files related to the page the operator is actively editing along with a few adjacent pages.

The document editing module 320 applies received editing commands to the current intermediate document, generates an updated rendition for the modified intermediate document, and transmits the updated rendition to the eBook editing application 130 for display. The document editing module 320 may also avail the editing commands to the intermediate document generator 120 to improve algorithms applied by the intermediate document generator 120 to generate the intermediate documents. Once the document editing module 320 receives an edit complete command indicating that the operator has completed editing the book, the document editing module 320 converts the finalized intermediate documents into an eBook using the format converter 140 (not shown).

The data store 330 stores data used by the server 170. Examples of such data include computer program code of the eBook editing application 130, intermediate documents and associated page images, received editing commands, and resulting eBooks.

### Example Architectural Overview of the EBook Editing Application

FIG. 3B is a high-level block diagram illustrating a detailed view of modules within the eBook editing application 130 according to one embodiment. In one embodiment, the eBook editing application 130 is implemented as a web application using JavaScript and HTML. Some embodiments of the eBook editing application 130 have different and/or other modules than the ones described herein. Similarly, the functions can be distributed among the modules in accordance with other embodiments in a different manner than is described here. As illustrated, the eBook editing application 130 includes a communication module 340 and a user interface (UI) module 350.

The communication module 340 communicates with the server 170 to receive page images and renditions of corresponding intermediate documents, and transmit editing commands received from the human operator.

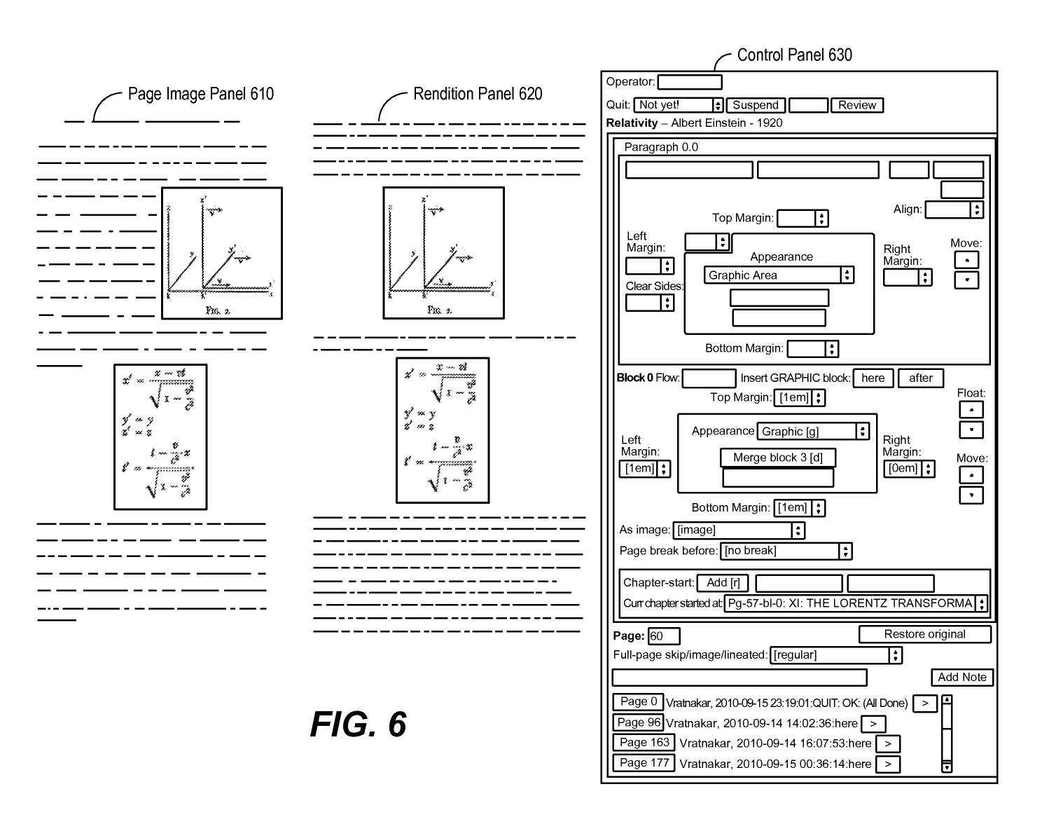

The UI module 350 generates a graphical UI (GUI) for the human operator to efficiently identify and correct errors in the intermediate documents. FIG. 6 is a screenshot illustrating one example GUI 600. As shown, the GUI 600 includes three panels: a page image panel 610 for displaying page images, a rendition panel 620 for displaying corresponding rendition side-by-side with the page images, and a control panel 630 for displaying editing commands for the operator to select from.

The GUI 600 enables the operator to edit the intermediate documents on a page-by-page basis (of the page images). The page image panel 610 displays the current page image and optionally displays portions of the adjacent page images (e.g., a bottom portion of the previous page and a head portion of the next page). The rendition panel 620 displays the rendition of the content extracted from the current page image (shown in FIG. 6 in black color) along with the content in the displayed portions of the adjacent pages (grayed out in FIG. 6 for clarity) for the operator to correct errors. Text from separate page images may be joined, depending upon whether the text paragraph(s) the text belongs continues or breaks.

The GUI 600 enables the operator to effectively identify and correct various types of errors in the rendition. By displaying the rendition in the rendition panel 620 alongside the page image from which contents of the rendition originates in the page image panel 610, the GUI 600 enables the human operator to observe the contents in their original forms and thereby efficiently identify and correct errors in the rendition. To correct low-level text errors (e.g., missing text), the operator can make the correction directly on the rendition panel 620 (e.g., by typing in the missing text). To enhance efficiency and accuracy, the GUI 600 displays an enlarged image segment containing the text segment being edited in a nearby pop-up box. To correct high-level structural/logical errors, the operator can highlight the problematic section in the rendition panel 620, and select the corresponding editing commands in the control panel 630.

Commands in the control panel 630 are organized into three groups: a paragraph group, a block group, and a page group. Commands in the paragraph group enable the operator to make changes within or throughout a specific paragraph. For example, the operator can adjust the margins, text alignment, text indentation, and font (e.g., size, weight, style, variant) as applied to a paragraph. The operator may also split a paragraph or merge the paragraph with another, or adjust the size of a non-textual element (e.g., image) in the paragraph. Commands in the block group enable the operator to make changes in a block level. For example, the operator can specify the appearance of the block (e.g., text body, quotation), split or merge the block, and adjust the margins as applied to a block. Commands in the page group enable the operator to operate on a page level, such as skipping certain book pages without editing them, or restoring the content as originally generated by the intermediate document generator 120. Some or all of the editing commands can be set to have shortcut keys to further facilitate efficiency, and the operator can edit the shortcut key assignment as needed. Thus, the operator can easily make wide structural changes as well as low-level text changes in the intermediate documents through the GUI 600.

The UI module 350 transmits (through the communication module 340) received editing commands to the server 170 for the server to apply to the intermediate documents. In response, the UI module 350 receives from the server 170 the updated rendition reflecting the changes in the intermediate documents. Thus, the operator can make changes to the intermediate documents and observe results in real time through the GUI 600.

Overview of a Process for Editing an Intermediate Document using the EBook Editing Application

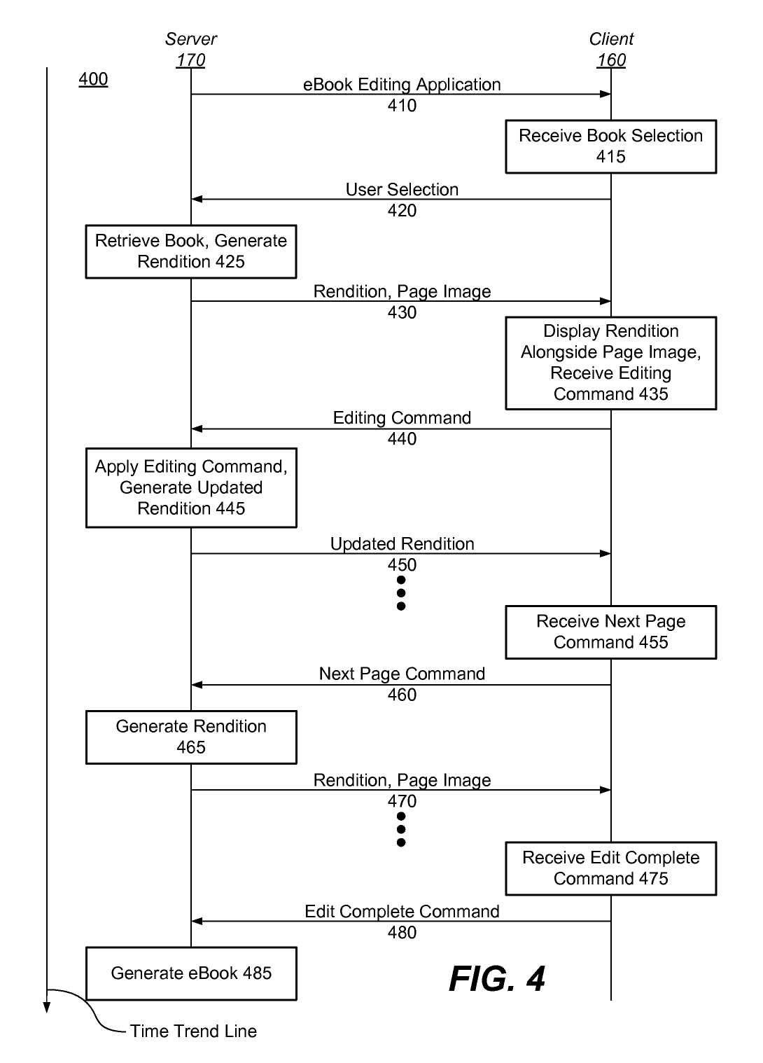

FIG. 4 is a ladder diagram illustrating a process 400 for using the eBook editing application 130 to edit intermediate document(s) of a book, according to one embodiment of the present disclosure. Other embodiments can perform the steps of the process 400 in different orders. Moreover, other embodiments can include different and/or additional steps than the ones described herein.

Initially, the operator launches the web browser 165 on the client 160 to download 410 the eBook editing application 130 from the server 170. The client 160 receives 415 a selection from the operator identifying a book to edit, and transmits 420 the book selection to the server 170. In response, the server 170 retrieves 425 files related to the selected book from the data store 330 and loads them into memory. The server 170 generates 425 a rendition of contents extracted from a current page (e.g., the first page) of the book, and transmits 430 the rendition along with the page image of the current page to the client 160. The client 160 displays 435 the page image alongside the rendition in the GUI 600, and receives 435 an editing command correcting an error in the rendition. The client 160 transmits 440 the command to the server 170, which modifies the intermediate document by applying 445 the command, generates 445 an updated rendition for the modified intermediate file, and transmits 450 the updated rendition to the client 160 to reflect the change made in response to the editing command. Steps 435-450 repeat until the operator finishes editing the current page, and advances to the next page. The client 160 receives 455 a next page command, and transmits 460 the command to the server 170, which makes the next page the current page, generates 465 a rendition of the current page, and transmits 470 the rendition and the page image of the current page to the client 160 for display. Steps 435-470 repeat as the operator corrects errors in each book pages until the operator finds the rendition satisfying (e.g., free of errors). The client 160 receives 475 an edit complete command and transmits 480 the command to the server 170, which generates 485 the resulting eBook by converting the finalized intermediate documents into a reflowable digital format (e.g., HTML), and avails the eBook to the readers.

When necessary, the process 400 is conveniently amenable to applying additional corrections to an eBook. For example, customers/readers may provide feedback identifying errors in the eBook such as a missing word/paragraph. After learning such errors, the operator can simply load up the eBook editing application 130, review the renditions of the relevant portions of the intermediate document alongside the corresponding page images, and make the necessary corrections. A corrected eBook can then be generated based on the corrected intermediate document and made available to the readers.

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a software application to assist human operators to efficiently identify and correct errors in electronic content. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

1. A computer-implemented method for editing an electronic book (“eBook”) based on a source document, comprising:
displaying a graphical user interface (GUI) comprising a display of content restrained to a fixed page layout including a page image and at least a portion of an adjacent page image generated from an optical scan of printed pages of the source document, and a display of a rendition of structured content in a reflowable format extracted from the displayed page image and the at least a portion of the adjacent page image, wherein the displayed rendition of structured content represents a single page that visually joins the content extracted from the page image and the content extracted from the at least a portion of the adjacent page image;
receiving an editing command from a human operator for modifying the displayed rendition of structured content to correct an error in the displayed rendition, wherein the editing command is generated responsive to an observation of the error in the displayed rendition based on a comparison of the displayed rendition with the display of content restrained to the fixed page layout;
responsive to receiving the editing command, displaying in the GUI an updated rendition of the structured content modified by the editing command in place of the displayed rendition;
receiving a next page command from the human operator; and
responsive to receiving the next page command, displaying in the GUI content restrained to a second fixed page layout including a next page image and at least a portion of a next adjacent page image generated from an optical scan of next printed pages of the source document and a display of a second rendition of structured content in a reflowable format extracted from the displayed next page image and the at least a portion of the next adjacent page image, wherein the displayed second rendition of structured content represents a second single page that visually joins the content extracted from the next page image and the content extracted from the at least a portion of the next adjacent page image.

2. The computer-implemented method of claim 1, further comprising:
receiving from a server the page image and the at least a portion of the adjacent page image of the source document and the rendition of the structured content extracted from the displayed page image and the at least a portion of the adjacent page image;
responsive to receiving the editing command, transmitting to the server the editing command; and
receiving from the server the updated rendition of the structured content modified by the editing command.

3-4. (canceled)

5. The computer-implemented method of claim 1, wherein the GUI further comprises a command panel comprising commands for correcting errors at a paragraph level, block level, and page level.

6. The computer-implemented method of claim 1, further comprising:
responsive to a user edit of a text segment in the displayed rendition of the structured content, displaying an enlarged image segment of the content restrained to the fixed page layout containing the edited text segment.

7-12. (canceled)

13. A non-transitory computer-readable storage medium encoded with executable computer program code for editing an electronic book (“eBook”) based on a source document, the computer program code comprising program code for:
transmitting an identifier of an eBook to a server;
receiving, from the server, a current page image of a current page in the identified eBook restrained to a fixed page layout and a rendition of structured content extracted from the current page in a reflowable format;
displaying a graphical user interface (GUI) comprising a display of the current page image of the current page restrained to the fixed page layout, and a display of the rendition of structured content in the reflowable format extracted from the current page image;
receiving an editing command from a human operator for modifying the structured content to correct an error in the rendition, wherein the editing command is generated responsive to an observation of the error in the rendition based on a comparison of the rendition with the display of content restrained to the fixed page layout;
responsive to receiving the editing command, displaying in the GUI an updated rendition of the structured content modified by the editing command in place of the rendition;
transmitting a next page command to the server;
responsive to transmitting the next page command, receiving, from the server a next page image of a next page in the identified eBook restrained to a fixed page layout and a rendition of structured content extracted from the next page in a reflowable format; and
displaying a GUI comprising a display of the next page image of the next page restrained to the fixed page layout, and a display of the rendition of structured content in the reflowable format extracted from the next page image.

14. The non-transitory computer-readable storage medium of claim 13, wherein the computer program code further comprises program code for:
responsive to receiving the editing command, transmitting to the server the editing command; and
receiving from the server the updated rendition of the structured content modified by the editing command.

15-16. (canceled)

17. The non-transitory computer-readable storage medium of claim 13, wherein the GUI further comprises a command panel comprising commands for correcting errors at a paragraph level, block level, and page level.

18. The non-transitory computer-readable storage medium of claim 13, wherein the computer program code further comprises program code for:
responsive to a user edit of a text segment in the displayed rendition of the structured content, displaying an enlarged image segment of the content restrained to the fixed page layout containing the edited text segment.

19. The computer-implemented method of claim 1, wherein the GUI displays the content restrained to the fixed page layout alongside the displayed rendition of structured content.

20. A computer for editing an electronic book (eBook) based on a source document, comprising:
a processor for executing computer-program instructions; and
a non-transitory storage medium for storing computer program instructions executable to perform steps comprising:
displaying a graphical user interface (GUI) comprising a display of content restrained to a fixed page layout including a page image and at least a portion of an adjacent page image generated from an optical scan of printed pages of the source document, and a display of a rendition of structured content in a reflowable format extracted from the displayed page image and the at least a portion of the adjacent page image, wherein the displayed rendition of structured content represents a single page that visually joins the content extracted from the page image and the content extracted from the at least a portion of the adjacent page image;
receiving an editing command from a human operator for modifying the displayed rendition of structured content to correct an error in the displayed rendition, wherein the editing command is generated responsive to an observation of the error in the displayed rendition based on a comparison of the displayed rendition with the display of content restrained to the fixed page layout;
responsive to receiving the editing command, displaying in the GUI an updated rendition of the structured content modified by the editing command in place of the displayed rendition;
receiving a next page command from the human operator; and
responsive to receiving the next page command, displaying in the GUI content restrained to a second fixed page layout including a next page image and at least a portion of a next adjacent page image generated from an optical scan of next printed pages of the source document and a display of a second rendition of structured content in a reflowable format extracted from the displayed next page image and the at least a portion of the next adjacent page image, wherein the displayed second rendition of structured content represents a second single page that visually joins the content extracted from the next page image and the content extracted from the at least a portion of the next adjacent page image.

21. The computer of claim 20, wherein the computer program instructions are further executable to perform steps comprising:
receiving from a server the page image and the at least a portion of the adjacent page image of the source document and the rendition of the structured content extracted from the displayed page image and the at least a portion of the adjacent page image;
responsive to receiving the editing command, transmitting to the server the editing command; and
receiving from the server the updated rendition of the structured content modified by the editing command.

22. The computer of claim 20, wherein the GUI further comprises a command panel comprising commands for correcting errors at a paragraph level, block level, and page level.

23. The computer of claim 20, wherein the computer program instructions are further executable to perform steps comprising:
responsive to a user edit of a text segment in the displayed rendition of the structured content, displaying an enlarged image segment of the content restrained to the fixed page layout containing the edited text segment.
